(19) United States
(12) Patent Application Publication
(10) Pub. No.: US 2013/0246504 A1
(43) Pub. Date: Sep. 19, 2013

(54) METHOD FOR SUBSCRIBING TO NOTIFICATION, APPARATUS AND SYSTEM

(71) Applicants: Lixin HU, Shenzhen (CN); Dexu LI, Shenzhen (CN)

(72) Inventors: Lixin HU, Shenzhen (CN); Dexu LI, Shenzhen (CN)

(73) Assignee: Huawei Technologies Co., Ltd, Shenzhen (CN)

(21) Appl. No.: 13/606,890

(22) Filed: Sep. 7, 2012

(30) Foreign Application Priority Data
Sep. 9, 2011 (CN) 201110268108.5

(51) Int. Cl. H04L 29/08

(52) U.S. Cl. CPC H04L 29/08693
USPC 709/203

(57) ABSTRACT

The present invention discloses a method for subscribing to a notification by a user terminal, an apparatus and a system. The user terminal includes a client, and the user terminal communicates with a website and a notification server via a network. The method includes the following steps: A browser obtains a webpage from the website, and presents the webpage; and the browser triggers, according to an event of the webpage, that the client sends a registration request to the notification server, where a registration request message includes a website identifier, so that the notification server pushes a notification of the website to the user terminal.

### CROSS-REFERENCE TO RELATED APPLICATIONS THIS APPLICATION CLAIMS PRIORITY TO CHINESE PATENT APPLICATION NO. 201110268108.5, FILED ON SEPTEMBER 09, 2011, WHICH IS HEREBY INCORPORATED BY REFERENCE IN ITS ENTIRETY.

### FIELD OF THE INVENTION

The present invention relates to a method for subscribing to a notification and an apparatus.

### BACKGROUND OF THE INVENTION

In a conventional client/server mode, a client requests a service or information from a server, and the server responds by transferring the information to the client. This is referred to as a pull (Pull) technology, and can be vividly described as that the client pulls the information from the server. Browsing a Web page is a typical example of the pull technology, where a user inputs a uniform resource locator (URL: Uniform Resource Locator) address which is submitted as a request to the server, and the server responds by sending the Web page to the user.

In contrast, there is also a push (Push) technology, which is also based on the client/server mode, but the client does not need to send a request to the server before the server transfers the information to the client, that is, the server actively pushes the information to the client. The pull is initiated by the client, while the push is actively initiated by the server. The push technology essentially lets information actively look for a user, and has the advantage of activeness and timeliness of the information.

FIG. 1 is a schematic diagram of a wireless application protocol (WAP: Wireless Application Protocol) push framework, in which a method for pushing information to a user equipment in the WAP is introduced, where the method includes: transferring, by a push initiator (PI: Push Initiator), push content and transmission specifications to a push proxy gateway (PPG: Push Proxy Gateway), and then transferring, by the PPG, the push content to a push client according to the transmission specifications.

The PI is generally an application running on a certain ordinary Web server, and the PI communicates with the PPG through a push access protocol (PAP: Push Access Protocol). The PAP protocol describes control information between the PI and the PPG through a standard extensible markup language (XML: Extensible Markup Language), and push content supported by the PAP protocol may be of any multipurpose internet mail extensions (MIME: Multipurpose Internet Mail Extensions) media type, and generally a hypertext transfer protocol (HTTP: Hypertext Transfer Protocol Overview) is used as a transmission protocol of PAP.

The PPG pushes information to the WAP push client through a push over-the-air (Push OTA: Push Over-the-Air) protocol, where the push over-the-air protocol can provide communication-oriented services, and can also provide communicationless services.

The PPG may need to translate a client address provided by the PI into a format understandable to a mobile network in a transfer process, or convert a format of the push content to adapt to a capability of a terminal, store push information when a current client is unavailable, and constantly try to push the information to the client in a validity period. The PPG may also process operations carried out by the PI, such as cancellation, replacement, or client capability determination.

The WAP push client authenticates the PI in a commissioned authentication manner. “Commissioned authentication” originates from a transitive principle of authentication. If a trust relationship can be established between the client and the PPG the PPG can authenticate the PI in place of the client. For example, after the client authenticates the PPG, the PPG is listed in a trust list, and the client can view a list of trustable PPGs. If the PPG has authenticated the PI, the client can also rightly authenticate the PI. The PPG authenticates the PI by using a trustable degree of different levels. The WAP push framework does not provide a user terminal with a function of notifying subscription to a notification, that is, the user cannot determine which PIs can actively push information to the client.

At present, companies such as Google and Apple provide a notification push platform. The kind of notification platform may send, through a website, a notification to a client application installed on a user terminal and provided by the website, and its technology is essentially a notification push mechanism. The disadvantage of the kind of notification platform lies in that subscription to a notification is initiated and completed by a client provided by the website. In order to push a notification to the user, the website need to provide its own client application for a user to install, while development of the client is a burden for the website in a case of numerous operating systems and increasingly updated versions of a current mobile terminal.

### SUMMARY OF THE INVENTION

An objective of the present invention lies in providing a notification push system convenient for user subscription and website use. Through the system, a user should be capable of conveniently and flexibly subscribing to a notification service of a website; and the website can acquire a capability of pushing a notification to a user terminal with small investment.

In a first aspect, the present invention provides a method for subscribing to a notification by a user terminal. The user terminal includes a browser and a client, and the user terminal communicates with a website and a notification server via a network, where the method includes: obtaining, by the browser, a webpage from the website, and presenting the webpage; generating, by the browser, a trigger event according to text content of the webpage; and sending, by the client, a registration request to the notification server according to the trigger event, where the registration request includes a website identifier of the website, so that the notification server pushes a notification of the website to the user terminal.

In a second aspect, the present invention provides a user terminal. The user terminal includes a browser and a client, where the browser communicates with a website via a network. The browser obtains a webpage from the website, presents the webpage, and generates a trigger event according to text content of the webpage; the client uses a terminal identifier to establish network communication with a notification server, and the client includes a notification receiving module and a registration management module; the registration management module receives the trigger event, obtains a website identifier corresponding to the webpage, displays an authorization interface to a user, and receives an authorization operation of the user on the website; the registration management module sends a registration request including the website identifier to the notification server according to the authorization operation of the authorization interface; and the notification receiving module receives a notification from the website from the notification server.

In a third aspect, the present invention provides a notification server. The notification server includes a registration module and a notification push module; the registration module receives a registration request which is of a terminal and includes a website identifier, saves a corresponding relationship between a terminal identifier and the website identifier; the registration module receives a notification push request of a website, where the notification push request includes notification content and a receiver identifier; the registration module searches for a corresponding terminal identifier according to the website identifier and the receiver identifier; if the corresponding terminal identifier exists, the registration module sends the notification content and the terminal identifier to the notification push module; and the notification push module sends the notification content to a user terminal according to the terminal identifier.

According to a fourth aspect, the present invention provides a notification push system, where the notification push system includes a user terminal and a notification server. The user terminal receives an event triggered by a webpage, obtains a website identifier corresponding to the webpage, displays an authorization interface to a user, and receives an authorization operation of the user on a website; according to the authorization operation of the authorization interface, the user terminal or the notification server generates a receiver identifier, and sends a permission message including the receiver identifier to the website; the notification server receives a notification which is of the website and includes the receiver identifier; and the notification server sends the notification to the user terminal according to the receiver identifier.

According to the present invention, the user can click or automatically run a link included in the webpage of the website in the browser, or a client script to trigger a notification subscription operation, so as to solve a problem of an inflexible user subscription manner in a notification push service. According to the present invention, a problem that the website needs to provide the client is also solved. The website only needs to produce a webpage meeting a standard format, and notification subscription can be flexibly added at a proper position in the webpage.

### BRIEF DESCRIPTION OF THE DRAWINGS

FIG. 1 is a system diagram of a WAP PUSH framework;

FIG. 2 is a block diagram of a user terminal and a notification server and website according to an embodiment of the present invention;

FIG. 3 is a schematic diagram of a webpage which is of a website and includes a button for triggering notification subscription according to an embodiment of the present invention;

FIG. 4A is a schematic diagram of an authorized record format saved by a registration management module of a user terminal according to an embodiment of the present invention;

FIG. 4B is a schematic diagram of a registration information format saved by a registration management module of a user terminal according to an embodiment of the present invention;

FIG. 5A is a schematic diagram of a registration record format which is of a user terminal and saved by a registration module of a notification server according to an embodiment of the present invention;

FIG. 5B is a schematic diagram of a registration record format which is of a website and saved by a registration module of a notification server according to an embodiment of the present invention;

FIG. 6 is a flow chart of user notification subscription according to an embodiment of the present invention;

FIG. 7A is a former part of a flow chart of notification message push according to an embodiment of the present invention;

FIG. 7B is a latter part of a flow chart of notification message push according to an embodiment of the present invention; and

FIG. 8 is a flow chart of receiving a notification message according to an embodiment of the present invention.

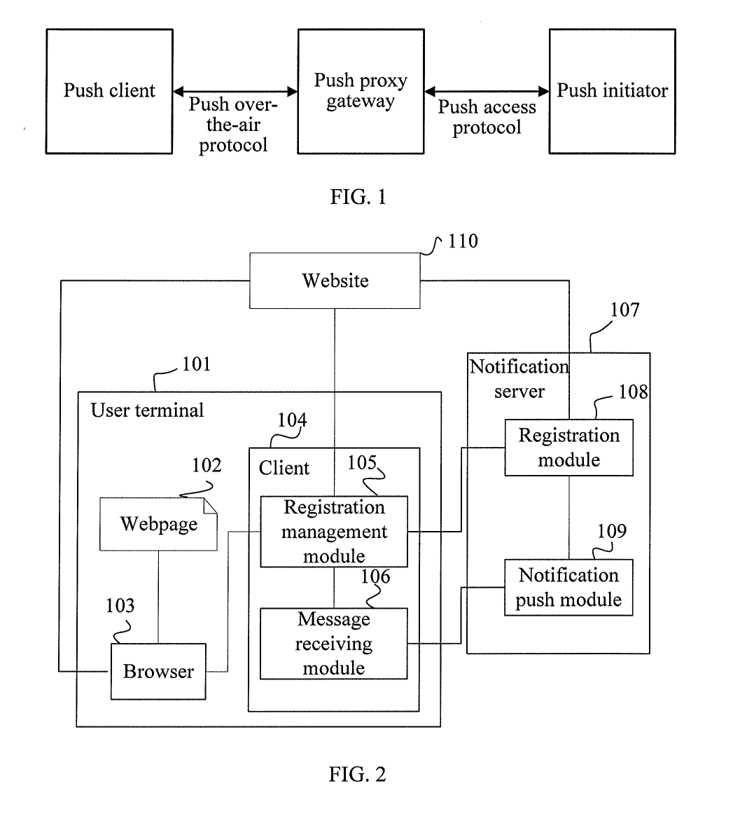

### DETAILED DESCRIPTION OF THE EMBODIMENTS

In order to make the objectives, technical solutions, and advantages of the present invention clearer, the present invention is further described in detail below with reference to the accompanying drawings.

FIG. 2 is a structural diagram of a notification push system according to an embodiment of the present invention. As shown in FIG. 2, the notification push system includes a user terminal 101, a notification server 107, and a website 110. The user terminal 101, the website 110, and the notification server 107 communicate with each other via a network. The user terminal 101 may be a mobile device, such as a mobile phone, a tablet computer, and a personal digital assistant (PDA: Personal Digital Assistant). The user terminal 101 receives an operation which is of subscribing to a notification and of a user, and sends a registration request to the notification server 107, and the notification server 107 sends a permission message through the user terminal 101 or directly to the website 110; and the website 110 actively pushes a notification to the notification server 107, and the notification server 107 pushes the notification to the user terminal 101.

In FIG. 2, the user terminal 101 includes a browser 103 and a client 104.

The browser 103 communicates with the website via the network. The browser 103 obtains a webpage from the website 110, and presents the webpage on the user terminal 101 according to text content of the webpage. Therefore, the user terminal 101 further includes a webpage 102. When the user performs a related operation according to the webpage, the browser 103 triggers a notification subscription event according to the webpage 102.

The client 104 may be client software, may be independent application software, and the client 104 may also be integrated into the browser or an operating system, so that the client 104 is part of the browser or the operating system. The client 104 is provided by a notification service provider, instead of a website provider. The client 104 includes a registration management module 105, and a notification receiving module 106.

The registration management module 105 communicates with the browser 103, and receives the notification subscription event of the browser 103. Then, the registration management module sends a registration request message to the notification server, where the registration request message includes a website identifier, indicating that a website corresponding to the website identifier is authorized to send a notification to the user terminal. The registration request message may further include a website self-defined parameter. The website self-defined parameter is one or multiple optional transparent transmission parameters, and its specific use is determined by the website itself. The website self-defined parameter may be used to identify a user or content, for example, a name of a stock to be selected or a registration name of a user at a website address. The website determines notification content to be sent to the terminal according to the website self-defined parameter.

The notification receiving module 106 communicates with the notification server 107, and receives and displays notification information pushed by the notification server.

The notification server 107 includes a registration module 108 and a notification push module 109. The notification server 107 saves a notification server identifier. The registration module 108 sends the permission message to the website according to the website identifier in the registration request message and a website address. The permission message includes a receiver identifier corresponding to a terminal identifier and the notification server identifier, and may also include the website self-defined parameter. In an optional solution, the notification server does not send the permission message to the website, but sends the permission message to the registration management module of the user terminal, and the registration management module forwards the permission message to the website.

The website determines the notification content to be pushed according to the website self-defined parameter, and then pushes a notification including the receiver identifier to the notification server.

In the notification server, the notification push module 109 determines the corresponding terminal identifier according to the receiver identifier, and pushes the notification to a user terminal corresponding to the terminal identifier.

A working process of the foregoing notification push system is discussed in detail below. Notification push is mainly divided into three stages including notification subscription, notification push, and notification receiving. First, a notification subscription process is discussed.

During installation or first running, the client 104 communicates with the notification server 108 via the network. The notification server 108 allocates a new terminal identifier for the client 104 that communicates with the network for the first time, and sends the terminal identifier to the client 104 via the network. The notification server 108 and the client both save the terminal identifier, and the terminal identifier is used in a message subsequently exchanged between the two, so that the notification server can uniquely identify the user terminal. In another optional solution, during installation or first running, the client reports a global unique identifier of the user terminal to the notification server. The client receives an acknowledgement of the notification server, and determines the identifier as a terminal identifier. The client and the notification server both save the identifier. The global unique identifier may be an IMSI (International Mobile Subscriber Identification Number, international mobile subscriber identification number), an IMEI (International Mobile Equipment Identity, international mobile equipment identity), and so on. The advantage is that the client software and the server can automatically determine the terminal identifier, so as to simplify user participation.

In addition, a corresponding password may be set for each terminal identifier. The user terminal and the notification server both save the terminal identifier and a corresponding password. The password can prevent a third party such as a website from forging the terminal identifier, so that the user terminal can establish a secure communication session with the notification server, and the notification server can obtain the corresponding terminal identifier from the communication session.

When the user pays attention to a certain website pushing a notification, the browser obtains a webpage for notification subscription from the website, and presents the webpage according to text content of the webpage. In an example, the webpage is a text file of an HTML format, and there is text content carrying a marker in the text file, for example, hyperlink (Link) and script language (JavaScript). The browser can interpret and execute the text content carrying the marker in the webpage, generate a corresponding DOM (DOM, document object model Document Object Model) node according to the text content carrying the marker, display HTML to the user, and execute an action of script language (JavaScript). The webpage may further trigger a corresponding webpage event according to the operation of the user, and the browser triggers a corresponding notification subscription event according to the webpage event.

For example, the webpage includes the following text content: “<a href=“PushRegister://3rd.com/?ack=regist_return_url&arg=self_str”> <img src=“register.gif”> </a>″. The text content can trigger a notification subscription event of the client software through the browser, and transfer the website identifier to the client software. register.gif is a button picture, and the browser displays the button picture for the user to click. PushRegister is a protocol name for marking a specific link, and the browser can notify the client according to the protocol name. 3rd.com is the website identifier, and the website identifier may be a domain name of the website. ack=regist_return_url is a path subsequent to the domain name in the website address URL; and this parameter ack=regist_return_url is optional; and if the parameter ack=regist_return_url does not exist, it indicates a constant default path or root path. arg=self_str is the website self-defined parameter. The website determines the notification content to be sent to the terminal according to the website self-defined parameter. The browser displays the button picture according to the foregoing text content, and generates the document object model (DOM: Document Object Model) node. When the user presses the button picture, this specific link is triggered, and the browser throws out a DOM event, that is, a PushRegister event. If during the installation or the first running, the client registers the PushRegister event, the browser triggers the event to the client, where the event includes the foregoing parameters: the website identifier 3rd.com, the website address regist_return_url, and the website self-defined parameter self_.

During the installation or the first running, the client registers the PushRegister event. The registration management module of the client receives the PushRegister event triggered by the webpage, and obtains, from the browser, the website identifier 3rd.com corresponding to the webpage, the website address regist_return_url, and the website self-defined parameter self_. Because when the browser obtains the webpage from the website, the HTTP protocol includes domain name information corresponding to the webpage, in an example, the domain name may be used as the website identifier. The client can use an attribute document.domain of the browser to obtain the website identifier corresponding to the webpage, and in this way, the website identifier may not be included in the text content of the webpage and the event. The website self-defined parameter may be obtained from a Cookie where the domain name of the website resides, in the browser, where the Cookie is from the website, and the client may obtain the Cookie as the website self-defined parameter, so that the webpage is written more concisely.

The advantage of adopting the solution in which the webpage triggers the event is that mainstream browsers and operating systems support event trigger at present. After the client software registers with the operating system, the client software may obtain the event of the specific link of the user for subscribing a notification in the webpage and these parameters, so that the client software can support multiple browsers. That is, no matter whether the user uses an IE browser, a Firefox browser, or a Chrome browser to visit the webpage, the user can subscribe to the notification.

The registration management module 105 may include an authorization interface, which is used by the user to authorize and manage a notification push website. The registration management module displays the authorization interface to the user, where the authorization interface includes the website identifier. The authorization interface may further include an interface element for the user to input the website to be authorized by the user, which prompts whether the user authorizes the website to send a notification to the user. The user may input an authorization operation of authorization or refusal. The registration management module 105 receives the authorization operation which is of authorization or refusal and of the user on the website.

The registration management module stores an authorization record in the user terminal. The authorization record includes the website identifier and a user authorization state. The authorization state is the authorization operation input by the user, and may be refusal or authorization, as shown in FIG. 4A.

If the authorization state is refusal, it indicates that the user refuses to let the website push a notification to the user.

If the authorization state is authorization, it indicates that the user authorizes the website to push a notification to the user.

The registration management module 105 further provides a function of deleting an interface. The registration management module shows an interface to the user, and the interface displays a website identifier list of FIG. 4A. The user deletes an authorization record stored in the user terminal through the interface, and an apparatus for deleting the interface communicates with the notification server, sends a corresponding website identifier to the notification server according to a deletion operation of the user, and receives a response of the server.

The registration management module sends the registration request message to the notification server according to the authorization operation of the authorization interface. The registration request message includes the website identifier, the website address, and the website self-defined parameter, indicating that the website corresponding to the website identifier is authorized to send a notification to the user terminal.

In the notification server, the registration module 108 communicates with the registration management module of the user terminal via the network, and receives the registration request sent by the registration management module.

The registration module obtains the terminal identifier of the user terminal during a network communication session, and saves the terminal identifier and the password corresponding to the terminal identifier. When the client uses the terminal identifier and the password to establish a relationship with the registration module, the registration module can distinguish, according to the terminal identifier, requests initiated by different user terminals. In this way, one notification server can support multiple user terminals. Specifically, the registration module receives a communication request from the client, and compares the terminal identifier and the password that are in the communication request with the terminal identifier and the password that are stored in the registration module. If the same, access is permitted, and the terminal identifier is recorded in session information, so that the terminal identifier may be obtained according to the session information in subsequent message processing.

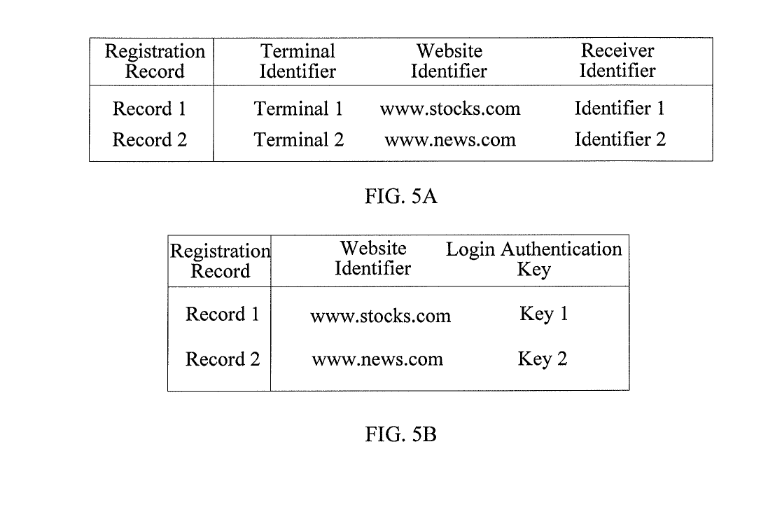

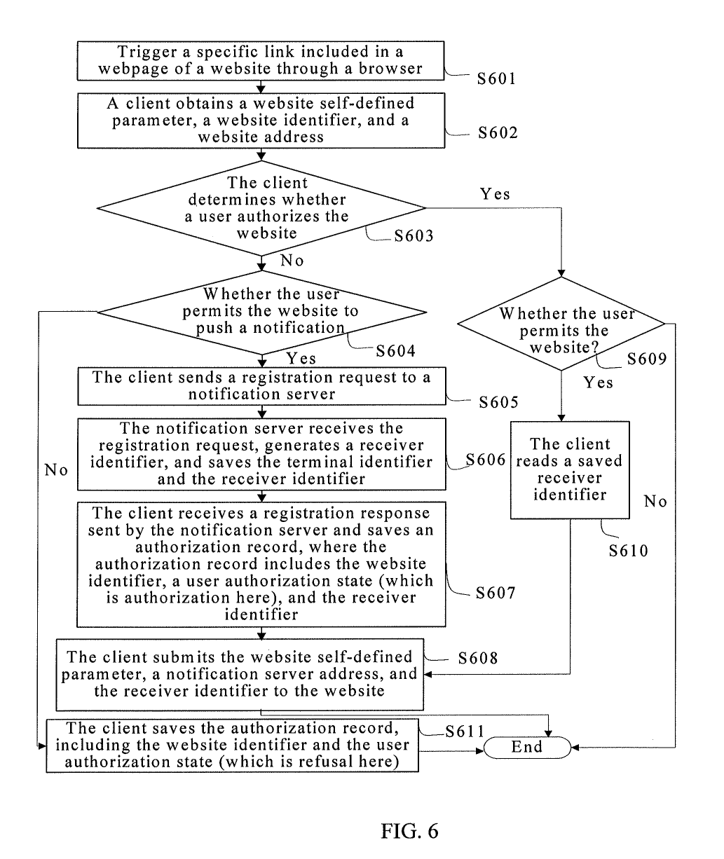

After receiving the registration request sent by the registration management module, the registration module generates the receiver identifier corresponding to the terminal identifier. The registration module encrypts the terminal identifier by using a corresponding password E_{K1}, where E_{K1} (terminal identifier) is used as the receiver identifier. The registration module may generate receiver identifiers in a sequentially incremental generating manner according to different terminal identifiers under a same website identifier. The registration module saves a corresponding relationship among the terminal identifier, the website identifier and the receiver identifier, as shown in FIG. 5A. In this way, one terminal identifier may be uniquely determined according to a website identifier and a receiver identifier. In another alternative solution, the registration management module generates the receiver identifier according to the terminal identifier and the website identifier, and the registration management module uses a password k1 corresponding to the terminal identifier to encrypt the terminal identifier and the website identifier, that is, E_{K1} (terminal identifier∥website identifier) is used as the receiver identifier. The registration module saves a registration record of the user terminal. The advantage is that each website obtains a different receiver identifier of a same terminal, thereby having better privacy.

The registration module sends the permission message to the website according to the website identifier and the website address, where the permission message includes the receiver identifier corresponding to the terminal identifier and the website self-defined parameter.

The website receives the permission message sent by the notification server, where the permission message includes the receiver identifier, the website self-defined parameter, and the notification server identifier. The website determines a user of the website according to the website self-defined parameter, and records a corresponding relationship among the website, the receiver identifier, and the notification server identifier. The notification server identifier is generally a domain name, and the website may establish communication with the notification server according to the notification server identifier.

In a case of a new notification server identifier, the website does not store the notification server identifier and a key, the website sends a website registration request to a notification server, where the request includes the website identifier, and receives a registration response of the notification server, where the response includes a login authentication key generated by the notification server. The website saves a received login authentication key and a corresponding notification server identifier.

In a case of a server identifier stored in the website, the website searches, according to the notification server identifier, for a login authentication key which corresponds to a notification server and is saved in the website, so as to establish secure communication with the notification server identifier by using the website identifier and the login authentication key.

After the foregoing notification subscription process is completed, the website carries out a notification push process at proper time. A specific process is as follows.

The website determines the notification content to be sent according to the website self-defined parameter; and determines the receiver identifier and the notification server identifier according to the user of the website, and sends the notification content corresponding to the user of the website and the receiver identifier corresponding to the user of the website to the notification server.

The registration module 108 receives a notification push request of the website, where the request includes the notification content, the receiver identifier, the website identifier, and the login authentication key. The registration module searches, according to the received website identifier, for a website registration record saved in the notification server, compares a login authentication key in the registration record and the received key for consistency, and authenticates the website. If the registration record does not exist, or the authentication is failed, a current notification push request is terminated. If the authentication is passed, the registration module searches, according to the website identifier and the receiver identifier, for the corresponding relationship saved in the registration module of the notification server, and searches for a terminal identifier corresponding to the website identifier and the receiver identifier. If the corresponding terminal identifier exists, the corresponding terminal identifier is obtained, and the notification content, the terminal identifier, and the website identifier are sent to the notification push module; and if a registration record of the user terminal does not exist, the current notification push request is terminated, and refusal information is returned to the website.

The notification server 107 includes the notification push module 109, and the notification push module receives the notification content, the terminal identifier and the website identifier that are sent by the registration module; and the notification push module finds corresponding network communication according to the terminal identifier, and sends the notification content and the website identifier to the user terminal.

In a notification receiving process, the notification receiving module of the user terminal communicates with the registration management module of the user terminal, the notification receiving module may send a website identifier in a received notification message to the registration management module, and the registration management module returns a corresponding authorization state. If the state is authorization, the notification receiving module parses the notification message according to an agreed format, extracts the notification content, and displays notification message data to the user in a reasonable manner. An optional display manner includes transferring the notification message to a message processing module of an operating system of a mobile terminal through popping of a desktop window without affecting use experience of the user, or through invoking of a message interface provided by the operating system of the mobile terminal, and uniformly displaying the notification message together with messages of other sources. If a corresponding state does not exist, the user is prompted to request authorization, or the notification is not displayed. If the state is prohibition, the notification is not displayed.

In the foregoing notification push system, the website identifier is used, so that the user terminal may subscribe to notifications of multiple websites; and the notification server identifier is used, so that the user terminal may subscribe to notification services through different notification servers, and the website may push notifications to the user terminal through different notification servers. Furthermore, the website provider does not need to provide a client program, and only needs to insert a corresponding special text field (which may be a link or a client script) into a webpage according to a template provided by a notification service provider, so that the website can push notifications to the user terminal with less investment.

It should be noted that, various messages transferred between the website, the user terminal, and the notification server generally should include a message header and a message body, and for a format, reference may be made to a universal standard format of a notification message.

The message body may be of any MIME content type, and includes multiple parts of different MIME content types; and the message header may include parameters such as content encoding, content type, content language, content length, content position, notification sending time and validity period.

Moreover, in FIG. 2, the connection between the registration management module 105 and the website 110 is optional, and is used for transferring the permission message by the registration management module 105 to the website 110. Two connections exist between the user terminal 101 and the website 110: one connection between the browser 103 and the website 110, the other connection between the registration management module 105 and the website 110, and the two connections may be implemented by the same physical connection. Similarly, two connections also exist between the client 105 and the notification server 107: a connection between the registration management module 105 and the registration module 108, a connection between the message receiving module 106 and the notification push module 109, and the two connections may also be implemented by the same physical connection.

In the preceding notification subscription process, the notification server directly sends the permission message to the website. Such a solution results in that, the client has high network efficiency, only needs to communicate with the notification server once, and does not need to communicate with the website to send the permission message.

However, the notification server may not directly send the permission message to the website, but sends the permission message to the registration management module of the user terminal, and then the registration management module forwards the permission message to the website.

In an example, the registration management module sends the registration request message to the notification server according to the authorization operation of the authorization interface, where the registration request message includes the website identifier. In the response of the notification server to the registration request message, the registration management module receives the receiver identifier which is generated by the notification server and corresponds to the terminal identifier. The registration management module saves the registration information, which includes the receiver identifier and the corresponding website identifier. The registration management module sends, according to the domain name corresponding to the website identifier and directly via the network, the permission message to the website by using the Http protocol, where the permission message includes the receiver identifier, the website self-defined parameter, the website address, and the notification server identifier. The website address is used as a path of the Http protocol. The website establishes network communication with the notification server according to the notification server identifier, so that the website may support corresponding notification servers according to different terminal software. The advantage of the solution is that privacy of the website is effectively protected, and a self-defined parameter does not pass through the notification server; and functions of the notification server and the website have very good independence, and the notification server does not need to send the permission message to the website.

In addition, in another optional example in which the permission message is sent to the website, the registration management module sends the permission message including the receiver identifier to the browser according to the authorization operation of the authorization interface. The browser, according to the text content of the webpage (the text content of the webpage defines triggering of a corresponding action according to an event of a received permission message sent by the registration management module), automatically forwards the permission message to the website, and attaches, in the permission message, the self-defined parameter and the website address that corresponds to the webpage.

In another example in which the permission message is sent to the website, the authorization record is stored in the terminal according to the authorization operation of the authorization interface. The browser also searches, according to the text content of the webpage, for the authorization record stored in the terminal; and the registration management module responds to the searching of the browser, and sends the permission message including the receiver identifier to the browser, and the browser sends the permission message to the website according to the text content of the webpage. The advantage of the solution is that: The website may process related information through a flexibly defined webpage script, without transferring the self-defined parameter and the website address to the client, thereby simplifying processing of the webpage and the website. For example, when the browser communicates with the website, a Cookie (“cookie”) of the browser may be used as the self-defined parameter, and the website address may also be flexibly processed by the website.

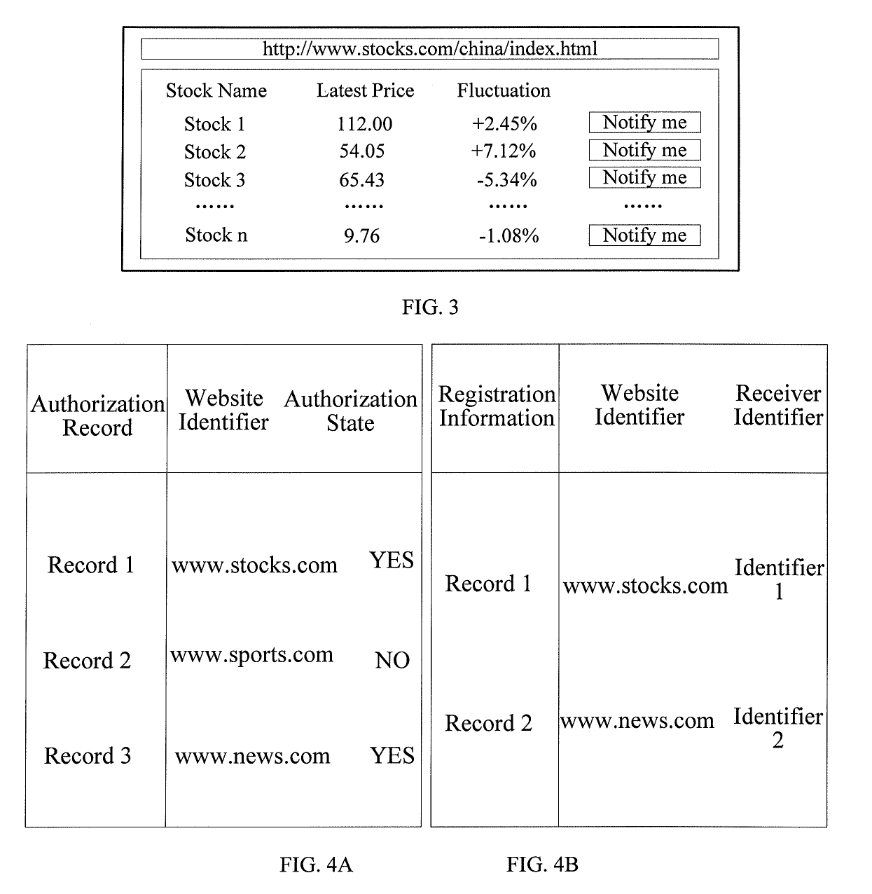

FIG. 3 is a schematic diagram of a webpage which is of a website and includes a specific link or a client script, where the specific link or the client script is for triggering notification subscription, according to an embodiment of the present invention. In the schematic diagram of the webpage, the specific link or the client script, where the specific link or the client script is for triggering notification subscription, is included in a webpage code corresponding to each “notify me” button. In other embodiments, the webpage may also automatically trigger execution of the specific link or the client script without a click of a user. In the webpage of the website, multiple similar “notify me” buttons including specific links or client scripts may be provided. In the schematic diagram of the webpage, dynamic fluctuation of multiple stocks is shown, and a “notify me” button including a specific link or a client script is set for each stock. After the user clicks the “notify me” button corresponding to a certain stock, a relevant entity obtains a website identifier, a website self-defined parameter corresponding to the stock, and a website address corresponding to the stock, and triggers a process of subscribing to dynamic information of the stock. After successful subscription, the website may push the dynamic information of the stock to the user through a notification server. The user may click to select and subscribe to dynamic information of multiple stocks.

As described above, notification push may be mainly divided into three stages including notification subscription, notification push, and notification receiving. Processes implemented at different stages are discussed in detail below.

FIG. 6 is a flow chart of notification subscription according to an embodiment of the present invention. As shown in FIG. 6, in step S601, a user accesses a network through a browser of a user terminal. The browser visits a certain website according to a URL address (for example, www.3rd.com) of the website, downloads a webpage from the website through the HTTP protocol, and triggers a specific link included in the webpage. For example, after the user opens a website page as shown in FIG. 3, the user clicks any “notify me” button, to trigger a specific link included in the webpage button.

The webpage is generally a text file of an HTML format, and text content carrying a marker is added to the text file, for example, hyperlink (Link) and script language (JavaScript). The browser can interpret and execute the webpage to display HTML to the user, and execute actions of the hyperlink (Link) and the script language (JavaScript).

In an example, the webpage includes text content indicating a specific link: “<a href=”PushRegister://3rd.com/?ack=regist_return_url&arg=self_step> <img src=“register.gif”></a>”. register.gif instructs the browser to display a button picture for the user to click. PushRegister is a protocol name for marking a specific link, 3rd.com is a website identifier, ack=regist_return_url is a website address receiving a receiver identifier. arg=self_str is a website self-defined parameter. When the link is triggered, the browser throws a document object model (DOM: Document Object Model) event. During installation or first running, if a client registers a PushRegister event, the browser triggers the event to the client, where the event includes the foregoing website identifier 3rd.com, the website address regist_return_url, and the website self-defined parameter self_str.

In step S602, the client obtains the website identifier, the website self-defined parameter, and the website address from the event.

For a user terminal running an Android operating system, a client may register the “PushRegister” event described in step S601 in the following manner.

In an AndroidManifest.xml file applied by the client, Intent-filter of Activity (activity) is defined:

<intent-filter>
<action android:name=“android.intent.action.VIEW” />
<category android:name=“android.intent.category.DEFAULT” />
<category android:name=“android.intent.category.BROWSABLE” />
<data android:scheme=“PushRegister” />
</intent-filter>

Data android:scheme is a self-defined protocol having a registration description format starting with “PushRegister://”. When the specific link starting with “PushRegister://” described in step S601 is triggered, the browser triggers the event to the client for processing, and transfers the following character string “3rd.com/?ack=regist_return_url&arg=self_str” to the client as a parameter. The client may obtain the character string through the following method:

final Intent intent = getIntent( );
final String str_dom = intent.getData( );

The character string str_dom is the foregoing character string including the website identifier 3rd.com, the website address regist_return_url, and the website self-defined parameter self_str.

Other mainstream operating systems also provide a similar mechanism of registering a self-defined protocol, so that when a specific link including a name of a registered protocol is triggered, the browser may invoke a designated application to process a corresponding event.

In this embodiment, a notification subscription process is triggered by clicking a specific link included in the webpage of the website by the user in the browser, so that a subscription manner is more flexible. After the notification subscription is successful, the user terminal (for example, a mobile phone) does not need to keep communication with the website, thereby reducing communication traffic and power consumption of a terminal. In addition, the client installed in the user terminal is provided by a notification service provider, instead of a website provider. The website only needs to insert a corresponding link to the webpage according to a template provided by the notification service provider. The website can push notifications to the user terminal with only small investment, which is beneficial to promotion of a notification service. In this embodiment, a specific webpage link template is “<a href=”PushRegister://website identifier/?ack=website address&arg=website self-defined parameter“> <img src=”icon file path“> </a>”. Moreover, the website may obtain more user information by transparently transmitting one or multiple self-defined parameters to the website, for example, willing, preference, and personal data of a user, so as to implement more accurate and personalized notification push, and improve user experience.

In step S603, the client determines whether the user authorizes the website according to the obtained website identifier and locally-saved user authorization information.

The client searches, according to the website identifier, for authorization state information which corresponds to the website identifier and is stored in the user terminal, and performs different processing according to the authorization state information. If it is determined that the user does not authorize the website, the process proceeds to step S604; and if it is determined that the user authorizes the website, the process proceeds to step S609.

In this embodiment, through a user authorization determination process, for a same website, the user terminal only needs to register once on a same notification server, so as to reduce interaction between the user terminal and the notification server, and reduce the communication traffic and the power consumption of the terminal.

In step S604, the client prompts the user to authorize the website, so that the user may control a notification service of an authorized or refused website. According to selection of the user, a user authorization state corresponding to the website is determined.

If the user authorizes the website to push a notification to the user, the process proceeds to step S605.

If the user refuses the website to push a notification to the user, the process proceeds to step S611.

In step S605, the client sends a registration request to the notification server, where the registration request includes the website identifier and the terminal identifier, indicating that the website is permitted to send a notification to the terminal.

The client obtains the terminal identifier stored in the user terminal, and establishes network communication with the server. Then, the client sends a registration request message, where the message includes the website identifier and the terminal identifier. If the client and the server have established a context session, the terminal identifier is included in server session information. Because the registration request message includes a session number, a corresponding terminal identifier may be found by means of the session number, and then the message indirectly includes information of the terminal identifier.

In step S606, the notification server receives the registration request sent by the client, generates a receiver identifier, and saves the terminal identifier and the receiver identifier.

Specifically, the server saves a corresponding relationship between the terminal identifier and the website identifier, and records authorization for the website to send a notification to the terminal. After the notification server receives a notification push request, the corresponding terminal identifier may be searched for based on the receiver identifier, and then the user terminal is addressed, so as to push a notification to the user terminal. For a same user terminal, receiver identifiers of different websites are different, which is helpful for protection of privacy of the user terminal.

There are two methods for generating a receiver identifier. One method is that, the notification server generates, according to a terminal identifier, a website identifier, and a random number generated by the notification server itself, a receiver identifier for a user terminal corresponding to the terminal identifier. For example, the random number is used as a password, to encrypt the website identifier, so as to generate a website password; and then the website password is used to encrypt the terminal identifier, to generate the receiver identifier. For an encryption algorithm, a symmetric encryption algorithm is adopted, for example, DES, IDEA, RC2, RC4, SKIPJACK, RCS, and AES algorithm. In this way, after receiving a receiver identifier sent by the website, the notification server performs decryption by adopting a corresponding website password, so as to obtain a terminal identifier. In this way, the receiver identifier does not need to be stored, thereby saving storage space. Another method is that, for each terminal identifier or website identifier, a non-repetitive receiver identifier is generated, so that a combination of the receiver identifier and the website identifier uniquely corresponds to a different terminal identifier. The notification server stores a relationship among the receiver identifier, the website identifier, and the terminal identifier. In this way, after receiving a receiver identifier sent by the website, the notification server searches for a corresponding stored terminal identifier according to the receiver identifier and the website identifier. The advantage of the method is that an operation is simplified, and an encryption operation is not needed.

In step S607, the client receives a registration response sent by the notification server, where the response includes a generated receiver identifier. The client saves the website identifier, the user authorization state (which is authorization here), and the receiver identifier. Then, the process proceeds to step S608.

In step S608, the client submits the receiver identifier to the website. The client submits the website self-defined parameter, the notification server identifier, and the receiver identifier to the website according to the website address. The subscription process ends.

In step S609, the client searches for an authorization state of the user for the website, and performs different processing according to the authorization state. If it is determined that the user authorization state is authorization, the process proceeds to step S610; otherwise, the process is terminated.

In step S610, the client reads the receiver identifier saved in the user terminal. Then, the process proceeds to step S608.

In step S611, the client saves the website identifier and the user authorization state (which is refusal here). Then, the process is terminated.

In another embodiment, the receiver identifier may be the terminal identifier saved in the client. In this case, the step of generating the receiver identifier in step S606 may be omitted, and parameters saved in the notification server are the terminal identifier and the website identifier. In step S607, the registration response received by the client may not include the generated receiver identifier, and the client only saves the website identifier and the user authorization state (which is authorization here).

In another embodiment, relative to steps in the subscription notification process described in FIG. 6, in step S601, a specific client script included in the webpage is triggered. In step S602, the client only obtains the website identifier from the webpage. Before step S608, a step of sending, by the client, the receiver identifier and the notification server identifier to the client script is further included. In step S608, the client script submits the receiver identifier, the website self-defined parameter, and the notification server identifier to the website according to the website address.

In this embodiment, the webpage includes the following text content representing the JavaScript script:

```
“<script language=“javascript”>
    var getRegData=“”;
    var SendWebsiteID=“3rd.com”;
    $(“#notify-me”).click(function( ) {
getRegData=window.client.requestPermission(SendWebsiteID);
    });
</script>”.
```

In the webpage shown in FIG. 3, the client script may be triggered by clicking any “notify me” button in the webpage by the user, and in this case, the button should include the following link: “<a href=”#” class=“button” id=“notify-me”>notify me<Ia>”.

In the foregoing JavaScript script, a variable SendWebsiteID saves the website identifier 3rd.com. The client is an alias of a Java object that is defined in the client and bound to the JavaScript script. When the JavaScript script is triggered, a requestPermission method defined in the Java object is invoked, that is, a function invoked event is triggered, the website identifier 3rd.com is transferred in the method, and then it is triggered that the client determines user authorization and registers with the notification server. The receiver identifier and the notification server identifier finally submitted by the client are saved in a variable getRegData.

Accordingly, the client includes the following WebView-based codes and methods:

```
mWebView.getSettings( ).setJavaScriptEnabled(true);
mWebView.addJavascriptInterface(new clientInterface( ),“client”);
mWebView.loadUrl(“http://www.3rd.com/index.html”);
final class clientInterface {
private String sendRegData=“”;
public String requestPermission(final String getwebsiteID) {
        sendRegData=permissionHandle(getwebsiteID);
        return sendRegData;
    }
public String permissionHandle (final String websiteID) {
        “user authorization determination and registration with
        notification server”
        return “receiverID&noticeServerUrl”;
    }
}
```

The variable sendRegData saves the receiver identifier and the notification server identifier. The setJavaScriptEnabled method is used to set whether a webpage JavaScript code may be executed in WebView, and if the parameter is true, it indicates yes. The addJavascriptlnterface method is used to bind a Java object clientlnterface stated in the client to JavaScript, a first parameter is the Java object clientlnterface, and a second parameter client is an alias of the object, and the alias is used when the method defined in the object is invoked in JavaScript. When the requestPermission method defined in the clientlnterface object is invoked through the foregoing JavaScript script, in the method, the website identifier 3rd.com is received, and saved in the variable getWebsiteID, and then the permissionHandle method is continuously executed, so as to perform user authorization determination and registration with the notification server, where a return value of the method is saved in a character string variable sendRegData, where information of the receiver identifier and information of the notification server identifier are included, and its format may be “receiverID&noticeServerUrl”. In the requestPermission method, the receiver identifier and the notification server identifier are finally sent to the JavaScript script.

The advantage of adopting the solution according to the embodiment is that, the webpage and the client may directly communicate, and transfer parameters to each other, and finally, the webpage, instead of the client, submits the parameters to the website, which simplifies functions of the client, and reduces a workload of client development.

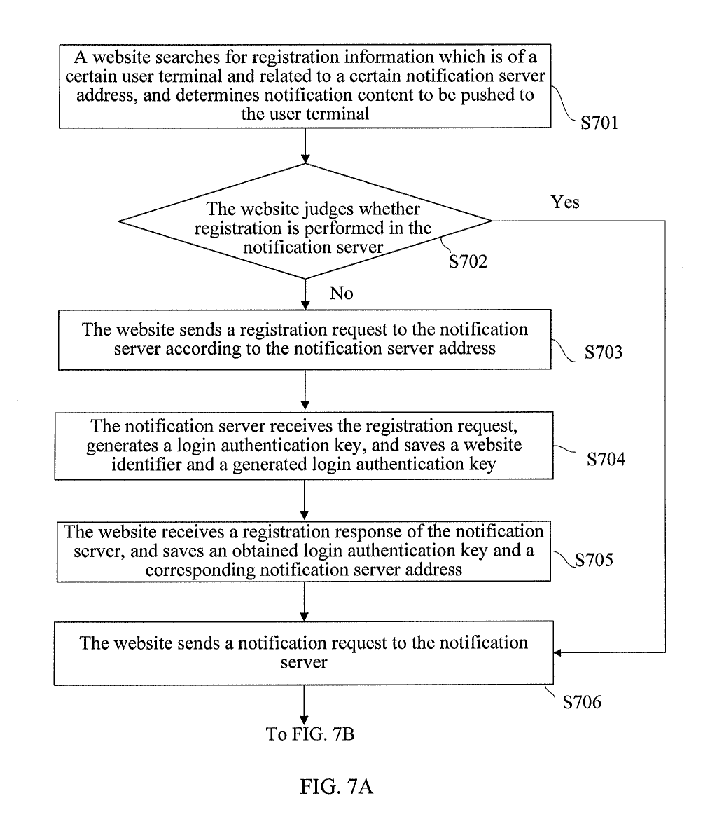

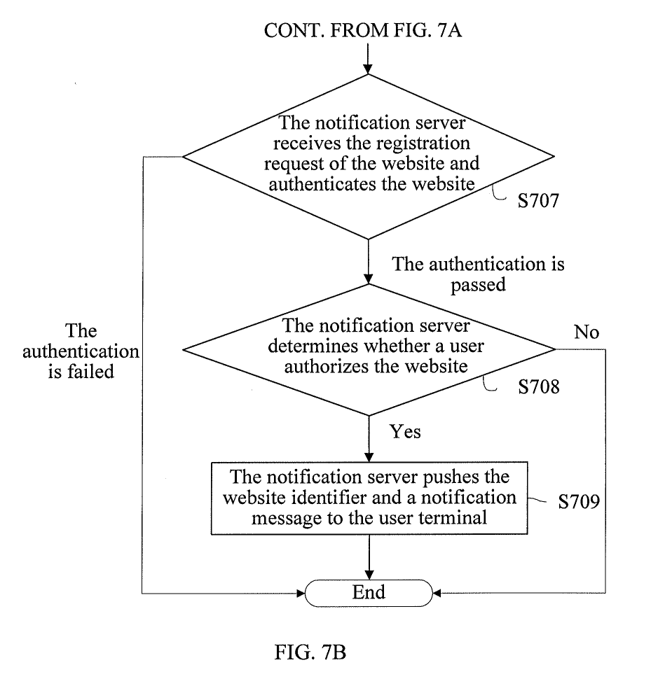

FIG. 7A is a former part of a flow chart of notification push according to an embodiment of the present invention.

As shown in FIG. 7A, in step S701, a website searches for registration information locally saved and related to a certain user terminal registered in a notification server. The registration information generally includes at least a receiver identifier, a notification server identifier, and one or multiple website self-defined parameters. The website determines notification content to be pushed with reference to the website self-defined parameter. Then, the process proceeds to step S702.

In step S702, the website searches, according to a received notification server identifier, for a login authentication key which corresponds to the notification server identifier and is stored in the website. According to a search result, the website performs the following processing.

If a corresponding login authentication key does not exist, it indicates that the website does not register in a corresponding notification server, and the process proceeds to step S703.

If a corresponding login authentication key exists, it indicates that the website registers in a corresponding notification server, and the corresponding login authentication key is directly read. Then, the process proceeds to step S706.

In step S703, the website sends a website registration request to the notification server according to the notification server identifier, where the request includes a website identifier. Then, the process proceeds to step S704.

In this embodiment, the website does not need to register with the notification server in advance, and a registration process may be dynamically triggered before the website sends a notification push request to the notification server for the first time, which, in a case that multiple notification servers exist in the network, simplifies a registration operation of the website, is beneficial to promotion of a notification service, and also makes deployment of an entire notification push system more flexible.

In step S704, the notification server receives the website registration request of the website, may generate a login authentication key for the website according to the website identifier included in the request and a random number generated by the notification server itself, and save the website identifier and a generated login authentication key. Then, the process proceeds to step S705.

In step S705, the website receives a registration response of the notification server, where the response includes the generated login authentication key. The website saves the notification server identifier and the login authentication key that is generated in registration. Then, the process proceeds to step S706.

In step S706, the website sends a notification request to the notification server according to the notification server identifier, where the request includes the website identifier, a notification message, the receiver identifier, and the login authentication key.

FIG. 7B is a latter part of a flow chart of notification push according to an embodiment of the present invention.

As shown in FIG. 7B, in step S707, the notification server authenticates the website according to a received website identifier and login authentication key. If the authentication is failed, the process is terminated; and if the authentication is passed, the process proceeds to step S708.

In step S708, the notification server searches, according to a received receiver identifier, for a corresponding relationship between a terminal identifier and the website identifier that is stored in the notification server, and performs the following processing according to a searching result. If the corresponding relationship between a corresponding terminal identifier and the website identifier exists, that is, a user has authorized the website, the corresponding terminal identifier is read, and then the process proceeds to step S712; if the corresponding relationship between the corresponding terminal identifier and the website identifier does not exist, and the user does not authorize the website, the process is terminated.

In step S709, the notification server pushes, according to the terminal identifier, the website identifier and the notification message to a user terminal corresponding to the terminal identifier. A notification push process ends.

In this embodiment, websites are centrally authenticated by the notification server, centralized user authorization and authentication are performed on notification push requests sent by the websites, and notifications are uniformly pushed, which is more secure and efficient.

In another embodiment, the notification server searches for the corresponding relationship between the terminal identifier and the website identifier in the notification server according to the received receiver identifier and website identifier, so as to determine whether the user has authorized the website.

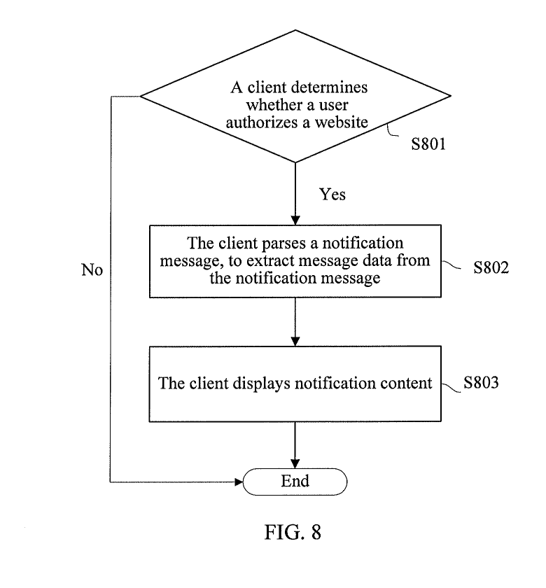

FIG. 8 is a flow chart of receiving a notification according to an embodiment of the present invention.

As shown in FIG. 8, in step S801, a client searches, according to a received website identifier, for a user authorization record stored in a user terminal, so as to determine whether a user has authorized a website. The client performs the following processing according to a user authorization state. If it is determined that the user has authorized the website to push a notification to the user, the process proceeds to step S802; otherwise, the process is terminated.

Here, the objective of determining user authorization is to prevent a problem that the user may still receive a notification sent by a certain website after the user sets, through a registration management module, that the website is refused continuously push of a notification, so as to improve user experience.

In step S802, the client parses a notification message according to an agreed format, to extract message data from the notification message. Then, the process proceeds to step S803.

In step S803, the client displays the notification message on the user terminal in a proper manner without affecting the user experience. A notification receiving process ends.

In other embodiments, a receiver identifier may also be provided by the client directly, and in this case, the receiver identifier may be a terminal identifier.

In the embodiment of the present invention, the notification subscription process is triggered by clicking a specific link included in a webpage of a website by the user in the browser, so that the subscription manner is more flexible. Furthermore, the client installed in the user terminal may be provided by a notification service provider, instead of a website provider, and the website only needs to produce a webpage meeting a standard format, and notification subscription may be flexibly added at a proper position in the webpage.

The objectives, technical solutions, and beneficial effects of the present invention are further described in detail through the foregoing specific embodiments. It should be understood that the foregoing description is merely exemplary embodiments of the present invention, but not intended to limit the protection scope of the present invention. Any modification, equivalent replacement, or improvement made without departing from the spirit and principle of the present invention should fall within the protection scope of the present invention.

What is claimed is:

1. A method for subscribing to a notification by a user terminal, wherein the user terminal comprises a browser and a client, and the user terminal communicates with a website and a notification server via a network, and the method comprises:
obtaining, by the browser, a webpage from the website, and presenting the webpage;
generating, by the browser, a trigger event according to text content of the webpage; and
sending, by the client, a registration request to the notification server according to the trigger event, wherein the registration request comprises a website identifier of the website, so that the notification server pushes a notification of the website to the user terminal.

2. The method according to claim 1, comprising: sending, by the notification server and according to the registration request, a permission message comprising a receiver identifier to the website.

3. The method according to claim 1, comprising: sending, by the notification server, a registration response message to the client according to the registration request, and forwarding, by the client, the permission message comprising the receiver identifier to the website.

4. The method according to claim 3, wherein the step of forwarding, by the client, the permission message to the website comprises: sending, by the client, the permission message to the browser, and forwarding, by the browser, the permission message to the website.

5. The method according to claims 1, comprising: sending, by the website, a notification push request to the notification server.

6. The method according to claim 5, wherein the permission message comprises a notification server identifier, and the method comprises: sending, by the website, a website registration request to the notification server, wherein the website registration request comprises the website identifier; receiving, by the website, a registration response of the notification server, wherein the response comprises a login authentication key generated by the notification server; saving, by the website, a received login authentication key and a corresponding notification server identifier, wherein when the website sends the notification push request to the notification server, the request comprises the login authentication key; and authenticating, by the notification server, the website by comparing a login authentication key in a registration record with a received key.

7. The method according to claim 5, wherein the permission message comprises the receiver identifier, and the notification push request comprises the receiver identifier; and the method comprises: searching, by the notification server and according to the website identifier and the receiver identifier, for a terminal identifier corresponding to the website identifier and the receiver identifier, and pushing notification content to the terminal according to the terminal identifier.

8. A user terminal, comprising a browser and a client, wherein
the browser communicates with a website via a network, and the browser obtains a webpage from the website, presents the webpage, and generates a trigger event according to text content of the webpage;
the client uses a terminal identifier to establish network communication with a notification server, and the client comprises a notification receiving module and a registration management module;
the registration management module receives the trigger event, obtains a website identifier corresponding to the webpage, displays an authorization interface to a user, and receives an authorization operation of the user on the website;
the registration management module sends a registration request comprising the website identifier to the notification server according to the authorization operation of the authorization interface; and
the notification receiving module receives a notification from the website through the notification server.

9. The user terminal according to claim 8, wherein the registration management module obtains a self-defined parameter corresponding to the webpage from the browser, and the registration request comprises the self-defined parameter.

10. The user terminal according to claim 8, wherein, according to the authorization operation of the authorization interface, the registration management module obtains a receiver identifier corresponding to the terminal identifier, and sends a permission message to the website, wherein the permission message comprises the receiver identifier.

11. The user terminal according to claim 10, wherein the step of sending, by the registration management module, the permission message to the website comprises: obtaining, by the registration management module, the self-defined parameter corresponding to the webpage from the browser, and sending, by the registration management module, the permission message to the website via the network, wherein the permission message comprises a website self-defined parameter.

12. The user terminal according to claim 10, wherein the step of sending, by the registration management module, the permission message to the website comprises: sending the permission message to the browser, and sending, by the browser, the permission message comprising the self-defined parameter corresponding to the webpage to the website.

13. The user terminal according to claim 10, wherein the registration management module saves a corresponding relationship between the website identifier and the receiver identifier.

14. The user terminal according to claim 13, wherein the registration management module reads an authorization state corresponding to the website identifier, and selects different operations according to the authorization state:
if the authorization state corresponding to the website identifier does not exist, a registration request message is continuously sent; and
if the authorization state is refusal, sending the registration request message is terminated.

15. A notification server, comprising a registration module and a notification push module, wherein
the registration module receives a registration request which is of a terminal and comprises a website identifier, saves a corresponding relationship between a terminal identifier and the website identifier;
the registration module receives a notification push request of a website, wherein the notification push request comprises notification content and a receiver identifier;
the registration module searches for a corresponding terminal identifier according to the website identifier and the receiver identifier;
if the corresponding terminal identifier exists, the registration module sends the notification content and the terminal identifier to the notification push module; and
the notification push module sends the notification content to a user terminal according to the terminal identifier.

16. The notification server according to claim 15, wherein
the registration module generates a receiver identifier according to the terminal identifier; and
the registration module sends a permission message to the website according to the website identifier, wherein the permission message comprises a receiver identifier corresponding to the terminal identifier.

17. The notification server according to claim 15, wherein
the registration module receives a website registration request which is of the website and comprises the website identifier; and
the registration module communicates with the website according to a domain name corresponding to the website identifier, to complete registration.

18. The notification server according to claim 16, wherein
the registration module receives a website registration request which is of the website and comprises the website identifier; and
the registration module communicates with the website according to a domain name corresponding to the website identifier, to complete registration.

19. A notification push system, comprising a user terminal and a notification server, wherein
the user terminal receives an event triggered by a webpage, obtains a website identifier corresponding to the webpage, displays an authorization interface to a user, and receives an authorization operation of the user on the website;
according to the authorization operation of the authorization interface, the user terminal or the notification server generates a receiver identifier, and sends a permission message comprising the receiver identifier to the website;
the notification server receives a notification which is of the website and comprises the receiver identifier; and
the notification server sends the notification to the user terminal according to the receiver identifier.
